(19) United States
(12) Patent Application Publication
(10) Pub. No.: US 2012/0294475 A1
(43) Pub. Date: Nov. 22, 2012

(54) METHOD FOR PREVENTING TRANSPORTATION DISASTERS

(76) Inventors: Vladimir Vasilievich Finogeyev, Moscow (RU); Dmitry Vadimovich Biryukov, Moscow (RU)

(21) Appl. No.: 13/519,222

(22) PCT Filed: Oct. 14, 2010
(86) PCT No.: PCT/RU2010/000583

§ 371 Date: Jun. 26, 2012

(30) Foreign Application Priority Data
Dec. 30, 2009 (RU) 2009149002

(51) Int. Cl. G06K 9/00

(52) U.S. Cl. 382/100

(57) ABSTRACT

The invention is used to prevent transportation disasters. The invention object is to provide taking into account of effect of destructive processes in a system “members of a transport crew/team—passengers” on generation of conditions resulting in a disaster of certain journey/trip/flight/rail run and thereby provide a sufficiently reliable prediction of the disaster so that to provide possibility of taking further effective measures to prevent this disaster. checkup of Scanned images of the hands of passengers arrived for certain journey/trip/flight/rail run and transport crew/team members appointed for this journey/trip/flight/rail run are checked up to detect an excited state of these passengers and transport crew/team members using markers of the excited state. A total excited state index of mass of the passengers and transport crew/team members of this journey/trip/flight/rail run are determined as ratio of a number of the passengers and transport crew/team members whose the excited state is detected to the total number of the passengers and the transport crew/team members of this journey/trip/flight/rail run. A disaster of this journey/trip/flight/rail run is forecasted by the total excited state index and, in the case of a positive forecast of the disaster, further measures to prevent the disaster of this journey/trip/flight/rail run takes. Markers of the excited state are combinations of dermatoglyphical features detected according to the results of the scanning and selected from the group of features characterizing a destructive dysplasia of papillary patterns, a general abnormality of the papillary patterns; a discontinuity; change of positions, configuration and size of three primary palmar creases; and single traits on three primary palmar creases.

### FIELD OF THE INVENTION

The present invention relates to a method of safeguarding different kinds of transport including air, railway, motor-vehicle, sea, river and space transports and is used to prevent disasters on these transports for the purpose of taking further measures to prevent such disasters.

### BACKGROUND OF THE INVENTION

Known in the art is a method of evaluation of a human state by assessment of state of human's chakras, comprising assessment of state of one of the palms using dermatoglyphics techniques and determination of specific chakra disorders (patent RU 2157083 C2, IPC7 A61B5/00, published in 2000). In this known method, it is not taken into account an effect of destructive electromagnetic oscillations occurring in the human body and in the system “members of a transport crew/team—passengers—vehicle—route” on secondary generation of conditions resulting in a disaster of certain journey/trip/flight/rail run.

In the present invention disclosure, a disaster is understood to mean a conventional term meaning an incident occurred as a result of a natural or technogeneous emergency and involved loss of life or any irreparable effects in history of some object (see for example http://ru.wikipedia.org).

In the present invention disclosure, the term “a transport crew/team” is understood to mean all technical and service staff presented on a vehicle during a journey/trip/flight/rail run to carry out and maintain this journey/trip/flight/rail run as well as to service the passengers of this vehicle.

### SUMMARY OF THE INVENTION

Physically, passengers of a journey/trip/flight/rail run with members of the transport crew/team and the vehicle itself are an aggregate physical mass. There are processes in the mass as a material structure, some of the processes are destroying or destructive and other ones are undestroying or nondestructive. This mass is considered hereinafter as an electromagnetic oscillation system. This system consists of a set of oscillations that divide into two large groups: destructive and nondestructive oscillations representing the material destructive and nondestructive processes respectively.

A traffic route can be taken as physical medium that is an oscillation system with sets of nondestructive and destructive configurations, which system includes a physical space with a nondestructive and destructive geomagnetic background, a meteorological factor (clouds or storm clouds, a wind velocity and wind direction, a mist or no mist, etc.), an aggregate mass of objects in air or terrestrial space in the route area (various civil and military vehicles, weather balloons, birds and other animals, traffic controllers, a takeoff and landing equipment, runways, a railroad bed, highways, support machines (escort machines, refuellers, etc.) and other elements.

In an ordinary case, the system “transport crew/team—passengers—vehicle—route” is characterized by dominance of nondestructive oscillations over destructive oscillations, which case is taken as the norm. But, in case of matching of all destructive processes in this system, an outrunning final destructive outcome (disaster) is generated. The outrunning outcome is generated as a result of a distant resonant interaction (frequency-amplitude-phase matching) of electromagnetic referents of the destructive processes in the above-mentioned components of the considered system.

As changing in microstates defines a macrostate which is, in general case, a consequence of the empirical law of change direction from micro level to macro level, hence micro processes are the cause of macro interactions. Therefore, there is a macro level delay relative to micro level interactions.

The micro level interactions, in turn, are caused by effect of factors summarized in a system of causal fields. Maximum destructive matchings of masses composing the system “transport crew/team—passengers—vehicle—route” initially appear in the system of causal fields. Hereinafter, such distant maximum destructive matching of the masses is referred to as “excited state”. The causal fields act as an inducer of distant maximum destructive electromagnetic interactions between the mentioned masses in the considered system, as a result of which, the destructive interaction of the physical solid masses is the last link that terminates a chain of the micro level interactions (in this paradigm, wave interactions are included in the micro level). The delay of the material destructive result makes it possible to preidentify and prevent this result.

An accessible indicator of generation of the destructive final result is the presence of a total excited state or critical level of the destructive oscillations in the system “passengers—members of transport crew/team”.

Since, as it will be shown below, correlation between the excited state of a human and his dermatoglyphical features has been experimentally defined, the total excited state can be detected by means of dermatoglyphical analysis preferably carried out by the use of a computer.

A dermatoglyphical conclusion of formation of the total excited state of the passengers and members of transport crew/team, that predict, a transport disaster, can be made by results of detection and count (preferably by means of a computer program specially made for this purpose) of specific dermatoglyphical features of the passengers and members of transport crew/team.

An object of the present invention is to provide a method of preventing transportation disasters, which takes into account effect of destructive processes occurring in the system “passengers—members of transport crew/team” on the secondary generation of conditions resulting in a disaster of certain journey/trip/flight/rail run and thereby provides a sufficiently reliable prediction of the disaster of this journey/trip/flight/rail run so that to provide possibility of taking further effective measures to prevent this disaster.

This object is accomplished, according to the present invention, by provision of a method for preventing transportation disasters, comprising:

checkup of scanned images of the hands of passengers arrived for certain journey/trip/flight/rail run and transport crew/team members appointed for this journey/trip/flight/rail run to detect an excited state of these passengers and transport crew/team members using markers of the excited state;

determination of a total excited state index of mass of these passengers and transport crew/team members of this journey/trip/flight/rail run, wherein the total excited state index is determined as ratio of a number of the passengers and transport crew/team members whose excited state is detected to the total number of the passengers and the transport crew/team members of this journey/trip/flight/rail run;

forecasting of a disaster of this journey/trip/flight/rail run by the total excited state index

and, in the case of the positive forecast of said disaster, taking further measures to prevent the disaster of this journey/trip/flight/rail run;

wherein markers of the excited state are combinations of dermatoglyphical features detected according to the results of the scanning and selected from the group of features characterizing:

a destructive dysplasia of papillary patterns,

a general abnormality of the papillary patterns,

a discontinuity; change of positions, configuration and size of three primary palmar creases, and

single traits on three primary palmar creases.

The dermatoglyphical features characterizing the general abnormality of the papillary patterns are multiple ulcerations of the papillary patterns, a micro-image phenomenon, a plural extirpation and a plural fragmentarity of the papillary patterns as well as multiple ridge widenings and a multiple ridge minutiae features protrusion.

As the further measures to prevent the disaster of this journey/trip/flight/rail run, measures are taken to decrease the total excited state index for this journey/trip/flight/rail run to an acceptable value. This total excited state index can be decreased by transfer of some of the passengers and/or transport crew/team members having the markers of the exited state to other journeys/trips/flights/rail runs and/or by invitation of other passengers and/or other transport crew/team members not having such markers to said journey/trip/flight/rail run.

This journey/trip/flight/rail run can be cancelled if it is impossible to decrease the total excited state index to the acceptable value by transfer of some of the passengers and/or transport the crew/team members having the markers of the excited state to other journeys/trips/flights/rail runs and/or by invitation of other passengers and/or other transport crew/team members not having such markers to said journey/trip/flight/rail run.

When carrying out the method according to the present invention, it is expected that all measures prescribed by appropriate laws, regulations, rules, instructions, etc. have been taken to ensure the technical operability and safety of the vehicle and all accessible elements of the vehicle route.

### BRIEF DESCRIPTION OF THE DRAWINGS

The method according to the present invention is illustrated by the following drawings:

FIG. 1, 2 present schemes of positions of three primary palmar creases and palmar areas on the right and left human hand respectively, which schemes are used when determining the excited state during carrying out the method according to the present invention;

FIG. 3 presents a scheme of positions of three primary palmar creases and palmar areas on the right human hand with positions of marker points on the primary palmar creases.

### DETAILED DESCRIPTION OF THE INVENTION

The present method is carried out in the following way.

Scanned images of the hands of passengers arrived for certain journey/trip/flight/rail run and transport crew/team members appointed for this journey/trip/flight/rail run are checked up before the departure of this journey/trip/flight/rail run. For this purpose, the hands of these passengers and transport crew/team members are scanned or earlier scanned hand images are used. Generally, the scanning can be carried out using any scanners available on the market, particularly by means of a mobile workstation for dactylographic registrations and express check “Papilon MKDS 40” developed and manufactured by ZAO “PAPILON”, Miass, Chelyabinsk Region, Russia.

Hereinafter, each passenger or transport crew/team member of this journey/trip/flight/rail run is referred to as “participant”.

Using the scanned images, dermatoglyphical features of all the participants are detected (preferably by a computer). Certain combinations of the dermatoglyphical features are taken as markers of the excited state (hereinafter referred to as “markers”). According to presence or lack of these markers, presence or lack of the excited state of each participant is detected. Then, a total excited state index DX₀ of mass consisting of the participants of this journey/trip/flight/rail run is determined as ratio of a number of the participants, the excited state of which is detected, to the total number of the participants of this journey/trip/flight/rail run.

If the total excited state index DX₀ is less than 30%, it is concluded that nonoccurrence of a disaster of this journey/trip/flight/rail run is probable (it is negative prognosis), and this journey/trip/flight/rail run is allowed to departure after the above-mentioned checkup of the participants. If the total excited state index DX₀ is more than 30%, it is concluded that occurrence of a disaster of this journey/trip/flight/rail run is probable (it is a positive prognosis), and the above-mentioned further measures are taken to decrease the index DX₀ to the acceptable value or this journey/trip/flight/rail run is cancelled.

The index DX₀=30% is taken as a boundary between the acceptable and unacceptable values on the grounds set forth below. Practical examinations of dermatoglyphical features of passengers of journeys/trips/flights/rail runs ended happily have shown that the number of the passengers having the excited state ranges within 1% to 30% of the total number of the passengers. Moreover, examinations of normal distribution of dermatoglyphical features of transport crew/team members participated in safe flights (pilots, flight engineers, flight stewards) performed with no passengers have revealed the same ratio of the number of the transport crew/team members having the excited state to the total number of the transport crew/team members.

Further, it is described in more detail the dermatoglyphical features that are studied to detect the excited state when implementing the present invention. An alpha-numeric designation is assigned to each dermatoglyphical feature, in which designation alphabetic and numeric signs are used as follows:

A, B, C are groups of the dermatoglyphical features the combinations of which are selected as the markers.

R means presence of a dermatoglyphical feature on the right hand;

L means presence of a dermatoglyphical feature on the left hand;

RL means presence of a dermatoglyphical feature on both hands.

A thumb, forefinger, middle finger, ring finger and little finger are designated by Roman numerals I, II, III, IV and V respectively.

Phalangeal bones are designated as follows: d is a nail (distal) phalange, m is a middle (intermediate) phalange, p is a lower (proximal) phalange.

The primary palmar creases are designated by K, M, T. The crease K, derived from kardia

(Greek), is a distal transversal palmar crease called traditionally as heart line. The crease M, derived from mentalis (Latin), is a middle transversal palmar crease called traditionally as head line. The crease T, derived from thenar (Greek), is a palmar crease surrounding the thenar and called traditionally as life line.

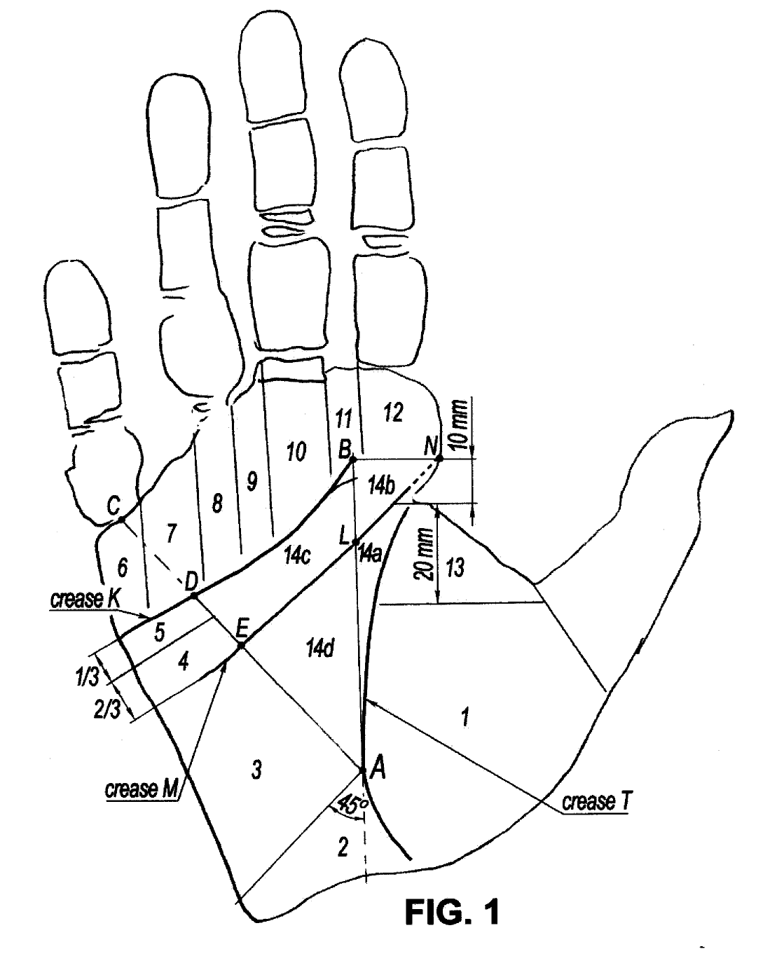

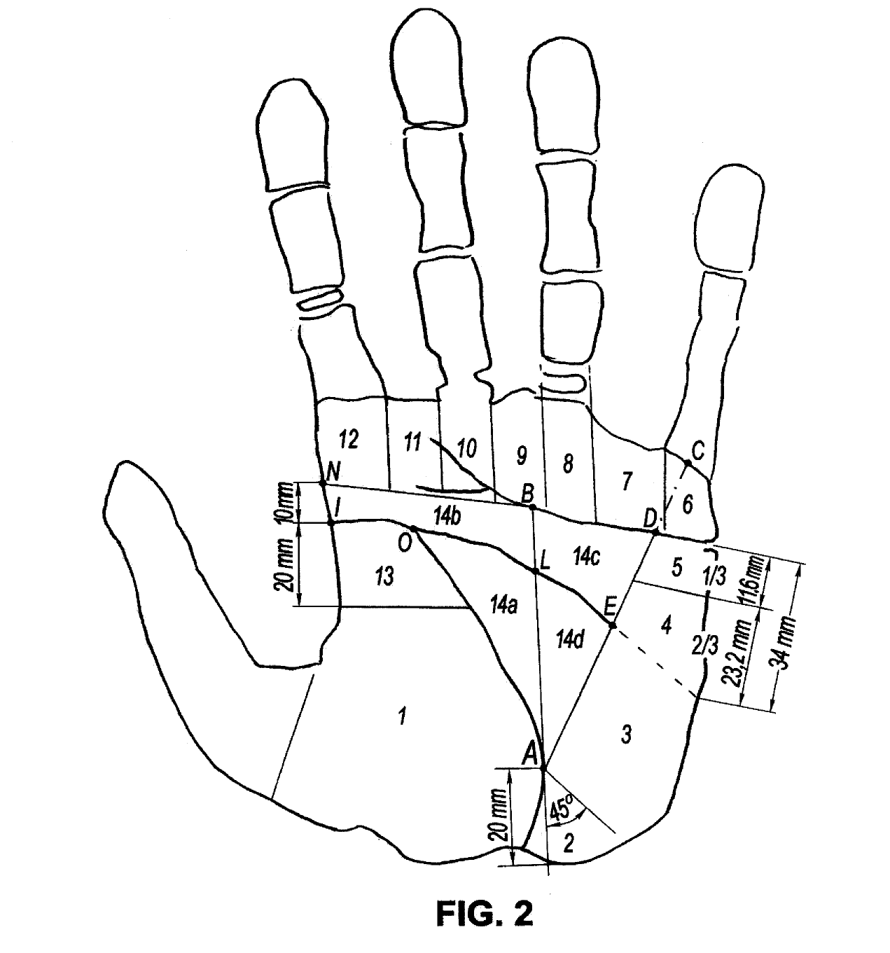

As presence of some dermatoglyphical features is associated with their disposition on a human hand, FIG. 1 presents schematically positions of the three primary palmar creases and palmar areas.

### Palmar Areas Description

In classical dermatoglyphics, a palmar area localization rule is used. The term “palmar areas” were introduced by H. Cammings and Ch. Midlo, founders of dermatoglyphics, to determine ends of main papillary lines on a palmar surface. The palmar areas are numerated in the counterclockwise direction beginning with the thenar, further in the direction of the base of the hand, further by ascending along the ulnar part of the hand to the subfinger pads from the V-finger to II-finger (i.e. from the little finger to the forefinger) taking in account interdigital spaces. There are thirteen palmar areas in total. The central part of the hand is not taken in account by H. Cammings and Ch. Midlo and herein designated as area 14 divided into four sectors 14a, 14b, 14c, 14d. Boundaries of the palmar areas are defined by the following way. A vertical line extends from the hand base end through a height of 20 mm to contact with the crease T thereby a point A is formed. This vertical line continues to intersection with the crease K thereby a point B is formed, while intersection with the crease M forms a point L. The point A is connected to a point C centered on a crease separated the V-finger from the hand. Intersections of the line AC with the creases K and M are designated by points D and E respectively. A length of 10 mm is measured from the beginning of the crease T along the radial hand edge to a point N. The points N and B are then connected. If the crease M is not connected with the crease T, as shown on FIG. 1, the crease M conditionally continues to the point N. As shown on FIG. 2, the crease M is connected with the crease T in a point O. Hence, on FIG. 1, the section ALN is the area 14a, the section LBN is the area 14b, the section DELB is the area 14c and the section ALE is the area 14d. On FIG. 2, the section ALO is the area 14a and the section INBL is the area 14b.

An area 2 is defined by a line extending to the carpal hand edge from the point A at an angle of 45 degrees with respect to the line AB and being a low boundary of an area 3. A top boundary of the area 3 is defined by conditional extension of the crease M along its natural run to the ulnar hand edge. This crease M extension is a low boundary of an area 4. An area 5 is one third of an area extending from the low boundary of the area 4 to the crease K. Areas 6 to 12 are defined by perpendiculars from boundaries of the finger bases to the K-crease, as shown on FIGS. 1 and 2. To define an area 13, a length of 20 mm is measured in distal direction from the source of the crease T and a transversal line is drawn to connect with the crease of the thumb base.

### Group A

A1. Destructive Dysplasia of Papillary Patterns

(local destructions of skin ridge patterns)

A1a—Figured dysplasia that is single or group protrusions of disintegrated ridges. The protrusions are of various elongated and weaving forms, their significant size is from 2 to 6 mm both in longitudinal and transversal directions.

A1a*c—Figured round type dysplasia. There are two kinds of this dysplasia:

1) Decayed ridge pattern minutiae features ptosis. This deviation has the form of a regular circle, ellipse or square of the size from 4 mm and more. The center of this deviation is distorted and raised above a common level of the papillary patterns. On a print, this deviation looks like a white circle, ellipse or square with a centered black spot.

2) This kind of the deviation has the form of a circle or ellipse with a point, multipoint or large-point centered elevation and a raised circumference. The papillary patterns within this form are undistorted. On a print, this deviation looks like a dark spot or a group of dark dots in the center of a form surrounded by a black line.

A1a*r—In-line type figured dysplasia. This deviation is group protrusions of some intact parts of the papillary patterns.

A1b—Granular dysplasia. It is a local large-grained, small-grained, grained-small-figured or island destruction of the papillary patterns. This deviation is most often located within circular boundaries. As opposed to the figured dysplasia, elements of the granular dysplasia are lowered, i.e. located below the common level of the papillary patterns, and have a significant size of 2 to 5 mm in diameter.

A1c—Ornament, its significant size is from 1 to 3 mm in transversal direction and no less than 4 mm in longitudinal direction (usual transverse-longitudinal size is 2×8 mm). This deviation is lowered with regard to the papillary patterns level.

Any feature A1 (A1a, A1b, A1c) in combination with any feature of the group B whose designation includes no elements italicized in the present disclosure (see corresponding explanations below when describing features of the group B) or in combination with any feature of the features C5e, C5f, C5g, C5h, C5i, C5j (see below) forms a marker. Herein, it is no matter whether the feature A1 is only on the right (R) or left (L) hand or on both hands (RL).

A2. General Abnormality of Papillary Patterns

A2d—Multiple ulcerations of papillary patterns (large-grained, medium-grained or small-grained papillary patterns defacement having no sharp boundaries). This abnormality is of the form of ulcers, and on a print, a black dot or spot inside a white circle is seen. It means that the inner part of the ulcer is raised and the outer one is lowered. Significant multiple ulcerations are such abnormality of a phalangeal bone or a palmar area in the amount of 31% to 100% and designated as A2d(≧31). Single ulcerations of papillary patterns on a palmar area or a phalangeal bone in the amount of no more than 30% are considered as the norm and designated as A2d(≦30).

A2e—Micro-image phenomenon. This is images formed on a palmar surface by means of papillary creases or more large creases in the form of a human—A2emn, a horse—A2ehrs, a dog—A2edg, a bird—A2ebd or various objects: a car—A2ecr, a railcar—A2etrn, a house—A2ehs, a boat—A2evsl, an airplane—A2eaic, a knife—A2eknf, an axe—A2eax, a gun—A2erfl and other figures—A2ez on the palmar areas 1 to 14.

A2f—Plural extirpation of papillary patterns. This is full lack of friction skin roundish segments, so called “island phenomenon”, on 31% to 100% of the total surface of all the palmar areas and the phalangeal bones, designated as A2f(≧31). Single extirpations in the amount of no more than 30% of one palmar area or one phalangeal bone are considered as the norm, designated as A2f(≦30).

A2g—Plural fragmentarity of papillary patterns. This is discontinuity of skin ridges with or without their microdisplacement on 31% to 100% of the surface of a palmar area or a phalangeal bone, designated as A2g(≧31). Separate fragmentations in the amount of no more than 30% of one palmar area or one phalangeal bone are considered as the norm, designated as A2g(≦30).

A2h—Multiple ridge widenings on 31% to 100% of the surface of the palmar areas 14c, 14d, 5, 4, 7, 8, 9, 10, 11, 12 or a phalangeal bone, designated as A2h(≧31). Separate widenings in the amount of no more than 30% of one palmar area or one phalangeal bone are considered as the norm, designated as A2h(≦30).

A2i—Multiple ridge minutiae features protrusion. This is outpouching of microelements of the papillary patterns on 31% to 100% of the surface of a palmar area or a phalangeal bone, designated as A2i(≧31). Such single protrusions in the amount of no more than 30% of one palmar area or one phalangeal bone are considered as the norm, designated as A2i(≦30).

A combination of any features A2d(≧31), A2e, A2f(≧31), A2g(≧31), A2h(≧31) and A2i(≧31) with any feature of the group B whose designation includes elements underlined in the present disclosure (see explanations below) or with any feature of C5e, C5f, C5g, C5h, C5i, C5j forms a marker.

### Group B

B1—Discontinuity of the Three Primary Palmar Creases T, M, K (Ruptures of the Primary Palmar Creases).

B1a—straight crease ruptures including a straight single open (noncompensated) rupture of one of the palmar creases T, M, K, in combinations of TM, TK, MK or in all the three creases TMK (1a): B1aT, B1aM, B1aK, B1aTM, B1aTK, B1aMK, B1aTMK.

B1aa—two straight ruptures of the palmar creases: B1aaT, B1aaM, B1aaK, B1aaTM, B1aaTK, B1aaMK, B1aaTMK. This feature revealed at least on one hand (R, L, RL) characterizes the most serious disturbance of the papillary patterns among the features of the group B and in combination with any feature A1 or any of A2d(≧31), A2e, A2f(≧31), A2g(≧31), A2h(≧31) and A2i(≧31) forms a marker.

Researches have revealed destructive importance of locations of the strait ruptures (B1a), displaced ruptures (B1b), forked open (noncompensated) (B1c, B1d), closed (compensated) ruptures (B1c) of the creases T, K, M. A closed (compensated) rupture is the rupture with a line located parallelly near and overlapping the rupture. An open (noncompensated) rupture does not has such overlapping line. Locations of discontinuity of these creases are determined by means of marker points.

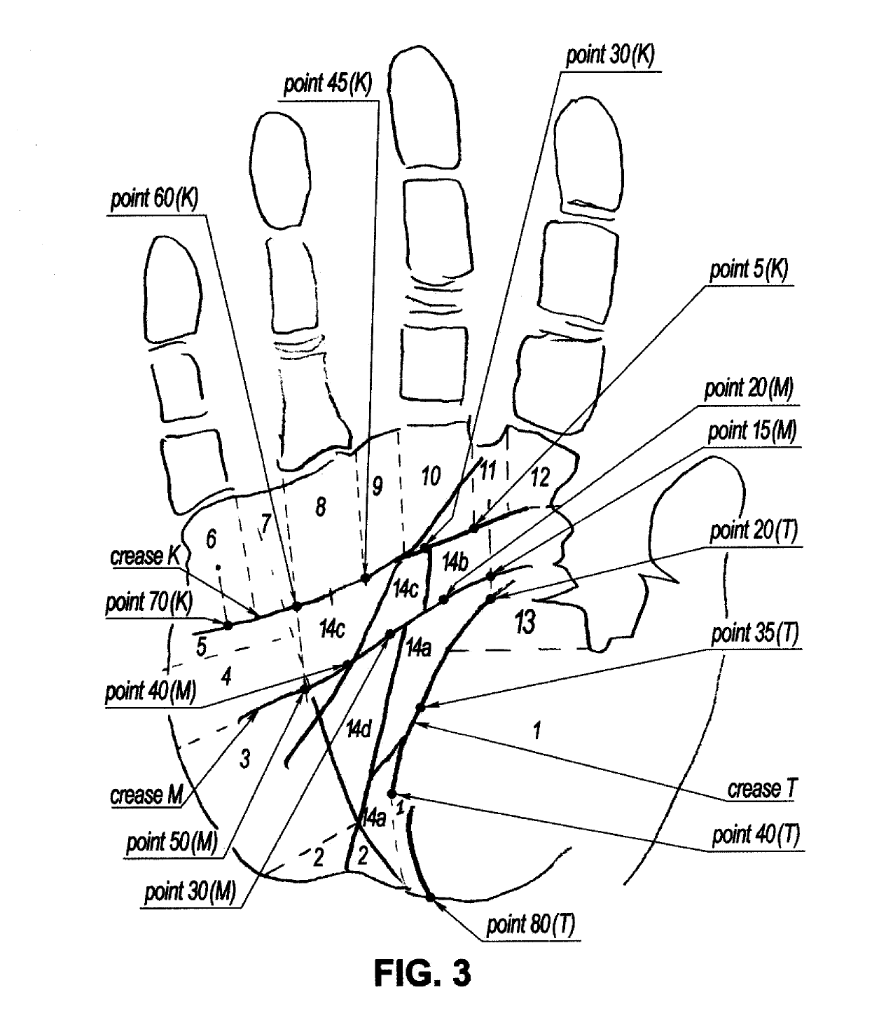

The marker points on the palmar crease T are defined by the following way (FIG. 3). The midpoint of the crease T is designated as a point 35. Beginnings and terminations of the palmar creases are instrumentally recognized while their true location may be ignored. A vertical line is drawn from the middle of the area 11 (between the forefinger and the middle finger) to the crease T. The intersection of this line with the crease T forms a point 20. The proximal remainder of the crease T (segment from the point 35 to the hand base) is divided into two equal parts thereby points 40 and 80 are formed.

Displaced, compensated and forked ruptures of the crease T between the points 35 and 20 on one hand only (R or L) and between the points 35 and 80 on both hands (RL) are empirically considered as significant ruptures with respect to determination of the excited state.

The marker points on the palmar crease M are defined by the following way (FIG. 3). A vertical line is drawn from the midpoint of the area 11 to the crease M. The intersection of this line with the crease M forms a point 15. Other vertical line is drawn from the boundary between the areas 7 and 8 to the crease M, and the intersection of this line with the crease M forms a point 50.

The middle between the points 15 and 50 is designated as a point 30. The distance between the points 15 and 30 is halved thereby a point 20 is formed. Similarly, the middle between the points 30 and 50 forms a point 40.

Displaced, compensated and forked ruptures of the crease M between the points 15 and 50 on one hand in the presence of abnormalities of the group A1 are empirically considered as significant ruptures with respect to determination of the excited state.

Forked ruptures and all kinds of compensated ruptures in the points >50 are considered as the norm if they are not accompanied by abnormalities of the groups A, B, C. Such ruptures in the points <15 have not been observed.

The marker points on the palmar crease K are defined by the following way (FIG. 3). A vertical line is drawn from the boundary between the areas 10 and 11 to the crease K, and the intersection of this line with the crease K forms a point 5. Other vertical line is drawn from the middle of the area 6 to the crease K thereby a point 70 is formed. A projection of the boundary of the areas 8 and 9 to the crease K forms a point 45. The middle between the points 45 and 70 is a point 60. The middle between the points 45 and 5 is a point 30.

Said kinds of the ruptures of the crease K in the points 5 to 70 on one or both hands in the presence of the abnormalities of the group A are empirically considered as significant ruptures with respect to determination of the excited state. The ruptures in the points <5 and >70 are considered as the norm if there are no other dermatoglyphical abnormalities.

A single open (noncompensated) displaced rupture of the creases T, M, K, TM, TK, MK and TMK (1b): B1bT, B1bM, B1bK, B1bTM, B1bTK, B1bMK, B1bTMK or two displaced ruptures (bb): B1bbT, B1bbM, B1bbK, B1bbTM, B1bbTK, B1bbMK, B1bbTMK.

In the below-mentioned designations of the dermatoglyphical features of the group B, any underlined element means that a combination of the group B feature with any feature A2d(≧31), A2e, A2f(≧31), A2g(≧31), A2h(≧31) and A2i(≧31) or with any A1 feature is sufficient to form a marker. If there are no underlined elements in the feature designation, a combination of this feature with any feature A1 is required to form a maker, and a combination of the feature B1b only with the above-mentioned features A2 is insufficient to form a marker.

For example, the feature B1bT35-40 (R, L, RL) characterizes a single displaced rupture of the crease T between the points 35 and 40. The underlined element RL means that a combination of this feature with one of the features A2d(≧31), A2e, A2f(≧31), A2g(≧31), A2h(≧31) and A2i(≧31) is sufficient to form a marker if this feature is on both hands. If this feature is on one hand only: B1bT35-40 (R, L), a combination of this feature with one of the features A1 is required to form a marker, and a combination only with said features A2 is insufficient to form a marker. An italicized element in a designation of the group B feature means that this feature does not form a marker.

Possible B1b features are as follows:

B1bT35-20 (R, L, RL)

B1bT35-40 (R, L, RL)

B1bT40-80 (R, L, RL)

B1bM15-50 (R, L, RL)

B1bM <15, >50 (R, L, RL)

B1bK 5-70 (R, L, RL)

B1bK <5, >70 (R, L, RL)

B1bT35-20, 35-40,M15-50 (R, L, RL)

B1bT40-80, M15-50 (R, L, RL)

B1bT35-20K5-70 (R, L, RL)

B1bT35-40K5-70 (R, L, RL)

B1bT40-80K5-70 (R, L, RL)

B1bI40-80 K<5,>70 (R, L, RL)

B1bK5-70M15-50 (R, L, RL)

B1bK<5, >70M<15,>50 (R, L, RL)

B1bT35-20, 35-40,M15-50,K5-70 (R, L, RL)

BT1bb35-20 (R, L, RL)

BT1bb35-40 (R, L, RL)

BT1bb40-80(R, L, RL)

B1bbM15-50 (R, L, RL),

B1bbM <15, >50 (R, L, RL)

B1bbK 5-70 (R, L, RL)

B1bbK <5, >70 (R, L, RL)

B1bb T35-20, 35-40,M15-50 (R, L, RL)

B1bb T40-80, M15-50 (R, L, RL)

B1bbT35-20K5-70 (R, L, RL)

B1bbT35-40K5-70 (R, L, RL)

B1bbT40-80K5-70 (R, L, RL)

B1bbT40-80K<5,>70 (R, L, RL)

B1bbK5-70M15-50 (R, L, RL)

B1bbK<5, >70M<15,>50 (R, L, RL)

B1bbT35-20, 35-40,M15-50,K5-70 (R, L, RL)

B1c—a noncompensated forked straight single rupture of the creases T, M, K: TM, TK, MK, TMK. Possible features are as follows:

B1cT35-20 (R, L, RL)

B1cT35-40 (R, L, RL)

B1cT40-80 (R, L, RL)

B1c M15-50((R, L, RL)

B1c M<15, >50((R, L, RL)

B1c K5-70(R, L, RL)

B1cK<5 >70 ((R, L, RL)

B1cT35-20M15-50 (R, L, RL)

B1cT35-40M15-50 (R, L, RL)

B1cT40-80M15-50 (R, L, RL)

B1cT40-80 M<15, >50(R, L, RL)

B1cT35-20K5-70 (R, L, RL)

B1cK5-70M15-50 (R, L, RL)

B1cT20-40M15-50K5-70 (R, L, RL)

B1cT40-80, M<15, >50, K<5−>70 (R, L, RL),

B1d—noncompensated forked single displaced rupture of the creases T, M, K: TM, TK, MK, TMK. Possible features:

B1dT35-20 (R, L, RL)

B1dT35-40 (R, L, RL)

B1dT40-80 (R, L, RL)

B1d M15-50((R, L, RL)

B1d M<15, >50(R, L, RL)

B1dK5-70 (R, L, RL)

B1dT35-20M15-50 (R, L, RL)

B1dT35-40M15-50 (R, L, RL)

B1dT40-80M15-50 (R, L, RL)

B1dT40-80 M<15, >50((R, L, RL)

B1dT35-20K5-70 (R, L, RL)

B1dK5-70M15-50 (R, L, RL)

B1dT20-40M15-50K5-70 (R, L, RL)

B1dT40-80, M<15, >50, K5-70 (R, L, RL)

B1e—all kinds of partially or fully compensated (closed) ruptures of one of the creases JI [symbol] X T, M, K, in combinationsB TM, TK, MK, of all the three creases TMK. A straight rupture—a, a split rupture—b, a displaced rupture—c, forked straight rupture—d, a forked displaced rupture—e, an intersection of the creases—f. Possible features:

B1eaT35-20 (R, L, RL)

B1eaT35-80 (R, L, RL)

B1ea M15-50(R, L, RL)

B1ea M<15, >50(R, L, RL)

B1eaK5-70 (R, L, RL)

B1eaK<5,>70 (R, L, RL)

B1eaT35-20M15-50 (R, L, RL)

B1eaT35-40M15-50 (R, L, RL)

B1eaT40-80M15-50 (R, L, RL)

B1eaT40-80 M<15, >50(R, L, RL)

B1eaT35-20K5-70 (R, L, RL)

B1eaT35-80 K5-70 (R, L, RL)

B1eaK5-70M15-50 (R, L, RL)

B1eaT20-40M15-50K5-70 (R, L, RL)

B1ea T40-80, M<15, >50, K<5, >70 (R, L, RL)

B1ebT35-20 (R, L, RL)

B1ebT35-80 (R, L, RL)

B1eb M15-50(R, L, RL)

B1ebM<15, >50(R, L, RL)

B1ebK5-70 (R, L, RL)

B1ebK<5,>70 (R, L, RL)

B1ebT35-20M15-50 (R, L, RL)

B1ebT35-40M15-50 (R, L, RL)

B1ebT40-80M15-50 (R, L, RL)

B1ebT40-80 M<15, >50(R, L, RL)

B1ebT35-20K5-70 (R, L, RL)

B1ebT35-80 K5-70 (R, L, RL)

B1ebK5-70M15-50 (R, L, RL)

B1ebT20-40M15-50K5-70 (R, L, RL)

B1eb T40-80, M<15, >50, K<5,>70 ((R, L, RL)

B1ecT35-20 (R, L, RL)

B1ecT35-40 (R, L, RL)

B1ecT40-80 (R, L, RL)

B1ec M15-50(R, L, RL)

B1ecM<15, >50(R, L, RL)

B1ecK5-70 (R, L, RL)

B1ecK<5,>70 (R, L, RL)

B1ecT35-20M15-50 (R, L, RL)

B1ecT35-40M15-50 (R, L, RL)

B1ecT40-80M15-50 (R, L, RL)

B1ecT40-80 M<15, >50(R, L, R)

B1ecT35-20K5-70 (R, L, RL)

B1ecT35-40 K5-70 (R, L, RL)

B1ecT40-80 K5-70 (R, L, RL)

B1ecK5-70M15-50 (R, L, RL)

B1ecT20-40M15-50K5-70 (R, L, RL)

B1ec T40-80, M<15, >50, K<5,>70 ((R, L, RL)

B1edT35-20 (R, L, RL)

B1edT35-40 (R, L, RL)

B1edT40-80 (R, L, RL)

B1ed M15-50(R, L, RL)

B1edM<15, >50(R, L, RL)

B1edK5-70 (R, L, RL)

B1edK<5,>70 (R, L, RL)

B1edT35-20M15-50 (R, L, RL)

B1edT35-40M15-50 (R, L, RL)

B1edT40-80M15-50 (R, L, RL)

B1edT40-80 M<15, >50(R, L, RL)

B1edT35-20K5-70 (R, L, RL)

B1edT35-40 K5-70 (R, L, RL)

B1edT40-80 K5-70 (R, L, RL)

B1edK5-70M15-50 (R, L, RL)

B1edT20-40M15-50K5-70 (R, L, RL)

B1ed T40-80, M<15, >50, K<5,>70 (R, L, RL)

B1eeT35-20 (R, L, RL)

B1eeT35-40 (R, L, RL)

B1eeT40-80 (R, L, RL)

B1ee M15-50(R, L, RL)

B1eeM<15, >50(R, L, RL)

B1eeK5-70 (R, L, RL)

B1eeK<5,>70 (R, L, RL)

B1eeT35-20M15-50 (R, L, RL)

B1eeT35-40M15-50 (R, L, RL)

B1eeT40-80M15-50 (R, L, RL)

B1eeT40-80 M<15, >50(R, L, RL)

B1eeT35-20K5-70 (R, L, RL)

B1eeT35-40 K5-70 (R, L, RL)

B1eeT40-80 K5-70 (R, L, RL)

B1eeK5-70M15-50 (R, L, RL)

B1eeT20-40M15-50K5-70 (R, L, RL)

B1ee T40-80, M<15, >50, K<5,>70 ((R, L, RL)

B1efT35-20—unobserved.

B1efT35-40 (R, L, RL)

B1efT40-80 (R, L, RL)

B1ef M15-50(R, L, RL)

B1efM<15, >50 (R, L, R L)

B1efK5-70 (R, L, RL)

B1efK<5,>70 (R, L, RL)

B1efT35-80M15-50 (R, L, RL)

B1dT40-80 M<15, >50(R, L, RL)

B1efT35-80K5-70 (R, L, RL)

B1efK5-70M15-50 (R, L, RL)

B1efT35-80M15-50K5-70 (R, L, RL)

B1ef T40-80, M<15, >50, K<5,>70 ((R, L, RL)

B2—change of positions of the three primary creases TMK (deviation from crease standard location).

B2f—displacement of the creases M, K—distal (d) or proximal (p) displacement: B2fMK (d, p) (R,L RL);

B2g—fragmentary duplications of the creases T, M, K, TK, TM, MK, TMK:
B2gT (R, L, RL), B2 gM (R, L, RL), B2gK (R, L, RL)
B2gTK (R, L, RL), B2gTM (R, L, RL), B2gMK (R, L, RL),
B2gTMK (R, L, RL).

B3—change of configuration of the T, M, K.

B3h—connection of the creases TMK at their beginnings: B3hTMK (R, L, RL).

B3h*—connection of the creases KM in other positions accordingly to the point locations: B3h*TMK (R, L,RL).

B3i—connection of the creases MK at their terminations: B3iMK (R, L, RL).

B3j—connection of the creases MT at their terminations: B3jMT (R, L, RL).

Local change of configuration of the creases TMK, TK, TM, MK:

B3k—local circular change of configuration of the creases T, M, K independently on location with respect to the points:
B3kT, M, K, TM, TK, MK, TMK (R, L, RL).

B3l—local angled change of configuration of the creases T, M, K independently on location with respect to the points:
B3lT, M, K, TM, TK, MK, (R, L, RL)
B3l TMK (R, L, RL)
B31 T40-80 (B,L,RL)

B4—change of size of the creases T, M, K.

B4m—lengthwise change—abnormal shortening of the creases T, M, K, TM, TK, MK:
B4mT (R, L, RL)
B4mM (R, L, RL)
B4mK, TM, TK, MK (R, L, RL)
B4mTMK (R, L, RL)

B4n—lengthwise change—lack of the start part of the crease M:
B4nM (R, L, RL)

B4o—widthwise change—abnormal wide one of or all the creases T, M, K accordingly to the point locations—from 2 [symbol] o 3 mm and more. Such widened creases are deepened most often, and skinfolds are raised above the bottom of the crease. Possible features:
B4oT (R, L, RL)
B4oM (R, L, RL)
B4oK (R, L, RL)
B4oTMK (R, L, RL)

B4p—widthwise change: abnormally narrow one of or all the creases T, M, K accordingly to the point locations—from 0.2 mm:
B4pT(R, L, RL)
B4p M(R, L, RL)
B4pK (R, L, RL)
B4pT M K (R, L, RL)

### Group C

This group of the dermatoglyphical features is auxiliary. It is required a combination of the features of the group C with the features of the groups A and B simultaneously to form a marker. Exception to this requirement are features C5e, C5f, C5g, C5h, C5i, C5j (see below) for which presence of the group B features is not required and which form a marker in combination with any feature A1 or any features A2d(≧31), A2e, A2f(≧31), A2g(≧31), A2h(≧31), A2i(≧31)

C1a—single deep cruciform figures on the areas 9, 10, 13, 5, 4, 3:
C1a9, 10 (R, L, RL) or C1a 9, 10, 13 (3, 4, 5) (R, L, RL). Presence of this feature in other palmar areas is considered as the norm.

C2b—single triangular figures on the areas 13, 3, 6:
C2b13 (3,6) (R, L, RL). Presence of this feature in other palmar areas is considered as the norm.

C3c—single circular figures on the areas 3-4, 13, 14ad:
C3c3 (4, 13, 14ad) (R, L, RL). Presence of this feature in other palmar areas is considered as the norm.

C4d—single star-shaped figures on the areas 10, 13, 14acd, 5:
C4d10 (13, 14a,14d, 14d) (R, L, RL). Presence of this feature in other palmar areas is considered as the norm.

C5—single lumps on the creases T, M, K:
C5e—circular: C5eT, C5eM, C5Ke (R, L, RL);
C5f—cruciform: C5fT, C5fM, C5fK (R, L, RL);
C5g—triangular: C5gT, C5gM, C5gK (R, L, RL);
C5h—star-shaped: C5hT, C5hM, C5hK (R, L, RL);
C5i—helmet-shaped: C5iT, C5iM, C5iK (R, L, RL);
C5j—angled: C5jT, C5jM, C5jK (R, L, RL).

C6—single lumps touching the creases T, M, K:
C6e—circular: C6eT, C6eM, C6Ke (R, L, RL);
C6f—cruciform: C6fT, C6fM, C6fK (R, L, RL);
C6g—triangular: C6gT, C6gM, C6gK (R, L, RL),
C6h—star-shaped: C6hT, C6hM, C6hK (R, L, RL);
C6i—helmet-shaped: C6iT, C6iM, C6iK (R, L, RL);
C6j—angled: C6jT, C6jM, C6jK (R, L, RL).

C7—additional deep isolated transversals on the creases T, M, K (an isolated transversal is a visible line 0.7 to 1 mm wide, whose beginning and termination are not connected with other creases) from the area 9, 10 to the area 1, from the area 9 to the area 14b, from the area 6, 7 to the area 1; an isolated transversal on the crease K from the area 6, 7 to the area 5, 14b, 14c, on the creases KM from the area 6, 7 to the area 14a, 14d; an isolated transversal from the areas 14d, 14a to the area 1 perpendicularly in the crease T with a shift thereof; an isolated transversal on the crease M in the marker points 15-50, from the area 14b to the area 14a, from the area 14c to the area 14d; transversals via the crease T from the area 2, 3, 4, 5 to the area 1; an isolated orthogonal termination of the creases M, T, K (designated as ^{⊥}):
C7k—straight or slightly curved intersectable crease-shift transversals or
C7kk—two straight or curved transversals: C7kK 6,7, 9→14b,14a,14c(R,L, RL); C7kTMK9,10→1(R, L, RL); C7kKMT6,7→1(R, L, RL); C7kkKMT6,7→1(R, L, RL); C7kK6,7→5, 14b, 14c (R, L, RL); C7kKM6,7→14a, 14d (R, L, RL); C7kkK6,7→5, 14b, 14c (R, L, RL); C7kkKM6,7→14a, 14d (R, L, RL); C7kKM6,7→14a,14d (R, L, RL); C7kkKM6,7→14a,14d (R, L, RL); C7kT14d,14a→1 (R, L, RL); C7kkT14d,14a→1 (R, L, RL); C7k15-50M14b→14a (R, L, RL); C7k15-50M14c→14d (R, L, RL); C7kk15-50M14b→14a (R, L, RL); C7kk15-50M14c→14d (R, L, RL); C7kT2,3, 4, 5→1(R,L RL); C7 M^{⊥} (R, L, RL); C7 T^{⊥} (R, L, RL); C7 K^{⊥} (R, L, RL).
C7l—straight or curved intersectable crease-shiftless transversals or
C7ll—two straight or curved transversals:

C7lT14a,14d,3,4→1 (R,L RL); C7lK6,7,8, 9→14b, 14c (R, L, RL); C7lM14a→14b, 14b→14d, 14b→13, 4→3 (R, L, RL); C7lTM14b,14c,5,4→1 (R, L, RL); C7lTMK9,10→1(R, L, RL); C7lKMT6,7→1(R, L, RL); C7llKMT6,7→1(R, L, RL); C7lK6,7→5, 14b, 14c (R, L, RL); C7lKM6,7→14a, 14d (R, L, RL); C7llK6,7→5, 14b, 14c (R, L, RL); C7llKM6,7→14a, 14d (R, L, RL); C7lKM6,7→14a,14d (R, L, RL); C7llKM6,7→14a,14d (R, L, RL); C7llT14d,14a→1 (R, L, RL); C7ll5-50M14b→14a (R, L,RL); C7l 15-50M14c→14d (R, L, RL); C7ll15-50M14b→14a (R, L, RL); C7ll15-50M14c→14d (R, L, RL).
C8m—an excessive transverse crease picture on the areas7-11: C8m (R, L, RL).
C9n—multiple star-shaped lumps on the areas 8, 10, 14a, 14b, 14c, 14d:
   C9n8, 10, 14a, 14b, 14c, 14d, (R, L, RL).
C10o—multiple cruciform lumps on the areas 3, 4, 5-5′, 6, 8, 14a, 14b, 14c, 14d:
   C10o 3, 4, 5-5′, 6, 8, 14a, 14b, 14c, 14d (R, L, RL).
C11p—multiple circular lumps on the areas 3, 4, 5-5′, 6, 8, 14a, 14b, 14c, 14d:
   C11p 3, 4, 5-5′, 6, 8, 14a, 14b, 14c, 14d, (R, L, RL).

C12—multiple spots and dots:
C12q—dark-colored, on the areas 1-14: C12q 1, 2 8, . . . 14 (R, L, RL);
C12r—red-colored, on the areas 1-14: C12r 1, 2, 3 . . . 14 (R, L, RL);

CE—ie-free zones or parts of the palmar surface (null-zones) on the areas 1-14:
CE 1-14 (R, L, RL).

From the foregoing it results that dermatoglyphical feature combinations necessary and sufficient to form a marker of the excited state are the combinations as follows:

a) A1+B (without italicized elements in the feature designations);

b) one of A2d(≧31), A2e, A2f(≧31), A2g(≧31), A2h(≧31), A2i(≧31) plus B (with italicized elements);

c) A1 plus C5;

d) one of A2d(≧31), A2e, A2f(≧31), A2g(≧31), A2h(≧31), A2i(≧31) plus C5.

Therefore, the dermatoglyphical features of any of the groups A, B, C, if revealed separately, represent some destructiveness but not the excited state and so, in the present invention, presence of the dermatoglyphical features of only one group or in combinations different from the above-listed combinations a) to d), is considered as the norm. Addition any other dermatoglyphical features to the combinations a) to d) does not affect formation of a marker or prevention of such formation, therefore detection, according to the results of the dermatoglyphical analyze, of the dermatoglyphical features not included into the combinations a) to d) does not affect detection of the excited state of a person but can be taken into account to estimate his state in more detail.

Industrial applicability of the present invention was confirmed by research of the dermatoglyphical features both in a group (the first group) of “safe-being” humans, i.e. people whose health did not undergo any catastrophic or extreme actions regarding their health and life, such as traffic accidents, severe home and employment injuries, casualties, life-threat assaults etc., and in a group (the second group) of humans exposed to such actions. Among the latter humans, there are persons currently dead of unnatural reasons (a lethal employment injury, death due to fire, random killing, road accident, willful homicide, air disaster). Hands of the persons dead in such a way were scanned while they were alive. Currently living persons of the second group have severe consequence of the injuries occurred (such as lower body immobilization as a result of various spine injuries, severe injuries as a result of traffic accidents etc. Researches have shown that all the persons of the second group have the dermatoglyphical feature combinations that form markers of the excited state according to the present invention. It will be appreciated that presence of state-excited persons converged in one place (especially in a vehicle) in excess of certain rate in respect of the total number of persons at this place increases the risk of destructive process developments at this place (object). The excited state markers of the majority of the first group persons revealed. Therefore, connection has been determined between the markers of the excited state in a human person and his high-risk of involving in various catastrophic consequences.

Usability of dermatoglyphical features for estimating the excited state of a human is also confirmed by published studies (see, for example, D. N. Stoyanovsky. Hand skin marking diagnostics of diseases. Practical dermatoglyphics.—Moscow, AST Publishers/Donetsk, Stalker Publishers, 2001). This publication discloses connection of dermatoglyphical features of a human person with his various diseases as well as various catastrophic events.

For example, in opinion of the author of said publication, a dermatoglyphical feature 4 (page 57-58, FIG. 50) is evidence of a violent death or a human death due to fire. According to the present invention, this feature is designated as C7lK9→14b. To form a marker, combination of this feature with the feature A1 and the feature B (without italicized elements).

Moreover, on page 66, FIG. 72 of said publication, it is shown a dermatoglyphical feature 3 meaning a blood accident. According to the present invention, this feature is designated as C5gM and forms a marker in combination with the feature A1 or any of the features A2d(≧31), A2e, A2f(≧31), A2g(≧31), A2h(≧31), A2i(≧31).

On page 67, FIG. 74 of said publication, it is shown other dermatoglyphical feature 4 meaning a violent death threat. According to the present invention, this feature is designated as C1a4,5, and its presence on both hands forms a marker only in combination with the features A1 or A2d(≧31), A2e, A2f(≧31), A2g(≧31), A2h(≧31), A2i(≧31) at necessary presence of the feature B (with an underlined element in its designation).

And finally, on pages 242-243, FIGS. 45 and 346 of said publication, it is shown features 2, 3 meaning a wound of both cerebral hemispheres/ This feature is A1a*c (RL) forming a marker together with C5 and B (without italicized elements).

What is claimed is:

1. A method for preventing transportation disasters, comprising:
checkup of scanned images of the hands of passengers arrived for certain journey/trip/flight/rail run and transport crew/team members appointed for said journey/trip/flight/rail run to detect an excited state of said passengers and transport crew/team members using markers of said excited state;
determination of a total excited state index of mass of the passengers and transport crew/team members of this journey/trip/flight/rail run, wherein the total excited state index is determined as ratio of a number of the passengers and transport crew/team members whose the excited state is detected to the total number of the passengers and the transport crew/team members of this journey/trip/flight/rail run;
forecasting of a disaster of said journey/trip/flight/rail run by said total excited state index and, in the case of a positive forecast of said disaster, taking further measures to prevent the disaster of said journey/trip/flight/rail run;
wherein markers of said excited state are combinations of dermatoglyphical features detected according to the results of said scanning and selected from the group of features characterizing:
a destructive dysplasia of papillary patterns,
a general abnormality of the papillary patterns,
a discontinuity; change of positions, configuration and size of three primary palmar creases, and
single traits on three primary palmar creases.

2. The method of claim 1, wherein the dermatoglyphical features characterizing general abnormality of the papillary patterns are multiple ulcerations of the papillary patterns, a micro-image phenomenon, a plural extirpation and a plural fragmentarity of the papillary patterns as well as multiple ridge widenings and a multiple ridge minutiae features protrusion.

3. The method of claim 1, wherein measures to decrease said total excited state index for said journey/trip/flight/rail run to an acceptable value are taken as said further measures to prevent the disaster of said journey/trip/flight/rail run.

4. The method of claim 3, wherein said total excited state index is decreased to the acceptable value by transfer of some of the passengers and/or transport crew/team members having said markers of said excited state to other journeys/trips/flights/rail runs and/or by invitation of passengers and/or transport crew/team members not having such markers to said journey/trip/flight/rail run.

5. The method of claim 3, wherein said journey/trip/flight/rail run is cancelled if it is impossible to decrease said total excited state index to the acceptable value by transfer of some of the passengers and/or transport the crew/team members having said markers of said excited state to other journeys/trips/flights/rail runs and/or by invitation of passengers and/or transport crew/team members not having such markers to said journey/trip/flight/rail run.
